(19) United States
(12) Patent Application Publication
(10) Pub. No.: US 2022/0274647 A1
(43) Pub. Date: Sep. 1, 2022

(54) MOTOR VEHICLE ASSEMBLY INCLUDING AN ATTACHMENT WHICH IS SECURED TO A HOLDING PART BY MEANS OF AT LEAST ONE SPACER WITH AN ADJUSTABLE LENGTH

(71) Applicant: Montaplast GmbH, Morsbach (DE)

(72) Inventors: Maik SCHNELL, Wissen (DE); Martin REX, Windeck (DE)

(21) Appl. No.: 17/626,196

(22) PCT Filed: Jul. 13, 2020
(86) PCT No.: PCT/EP2020/069770

§ 371 Date: Jan. 11, 2022

(30) Foreign Application Priority Data
Jul. 12, 2019 (DE) 20 2019 103 855.1

(51) Int. Cl. B62D 21/15

(52) U.S. Cl. CPC B62D 21/15

(57) ABSTRACT

A motor vehicle assembly including a stationary holding, an attachment movably arranged relative to the holding part, and at least one spacer extends between the holding part and the attachment for securing the attachment to the holding part. The at least one spacer includes an inner spacer part which lies on the inside in an installed position for securing to the holding part and a spacer outer part which lies on the outside in the installed position for securing to the attachment. A restoring spring is arranged between the spacer parts and counteracts a deflection after a force is introduced. In order to improve the functionality, the spacer parts engage into each other in a telescoping manner, and the restoring spring is received in the spacer parts in order to form an enclosed spring system which has an adjustable length.

The invention concerns a motor vehicle assembly according to the classifying portion of claim 1, that is to say a motor vehicle assembly including a substantially stationary holding part of a motor vehicle, that functions as a holding or mounting body, for example a vehicle body, an engine or the like, an attachment which is arranged moveably relative to the holding part and at least one spacer extending between the holding part and the attachment for fixing the attachment to the holding part.

The spacer fixes the attachment in a defined basic position in spaced relationship with the holding part. By virtue of a force acting thereon, for example an impact in the context of an accident, the attachment can be moved into a deflection position which is different from the basic position and which is closer to the stationary holding part.

The at least one spacer includes at least two spacer parts which are moveable relative to each other, more specifically an inner spacer part which is disposed inwardly in the installed position for fixing to the holding part and an outer spacer part which is disposed outwardly in the installed position for fixing to the attachment. The spacer parts are displaceable along a common spacer longitudinal axis which is preferably in the form of a linear guide, in relation to each other. In addition a return spring can be arranged between the spacer parts, the spring counteracting the deflection after the acting force.

Such motor vehicle assemblies or arrangements therefore include the attachment which in a set point position is arranged in a rest state or a basic position in spaced relationship with a stationary component and is held in that basic position by way of the adjustable-length spacer, preferably a plurality thereof. A particular situation of use of such attachments is a frame for mounting air flaps, that is to say an air guide or an air guide element which defines a front surface which can be opened and closed by means of displaceable flaps for controlling the air feed and for heat management in an engine compartment. Usually such an air flap holder or such a frame is disposed behind the “mouth” at the front end of a motor vehicle and thus forms the front air intake to the engine compartment.

Normally the spacer at an inward end is connected to the stationary component, for example the engine or the body, and at an outward end it is connected to the attachment, therefore for example the frame or the air flap control means.

The spacer parts, that is to say the inner spacer part and the outer spacer part, are displaceable in relation to each other along a common spacer longitudinal axis and thus in the event of a force acting thereon, for example in an accident, they permit displacement of the attachment, that is as well defined as possible in relation to the stationary component.

Accordingly a yielding function is implemented upon relative movement between the components in a crash situation.

A motor vehicle assembly of the specified kind is known from DE 103 32 377 A1. A motor vehicle assembly of another kind is disclosed in US 2018/0327032 A1.

### Disadvantages in the State of the Art

Sometimes a return spring is also provided between the two spacer parts, which is intended to provide for restoration after the impact or crash. The return spring however is operative laterally of the linear guide between the two spacer parts, that is to say in axis-displaced relationship from the spacer longitudinal axis and the spacer parts which are moving relative to each other, whereby the return spring exerts a torque on the linear guide which is preferably in the form of a dovetail guide configuration between the spacer parts, and that can adversely influence proper functionability.

Soiling of the spacers can also have an adverse influence on function, that is to say the relative movement.

The spacer or the motor vehicle assembly formed thereby can move out of its rest position for example in the event of vibration because the spring vibrates.

Installation within the engine compartment means that the guides are exposed to inevitable soiling, which in the extreme case can lead to jamming, which can go as far as complete malfunction so that the spacer parts cannot perform the necessary relative movement.

Finally the complex structure of existing configurations requires precise matching of the components to each other because the change in location from the basic position due to an impact, for example in the event of an accident, means that sensors arranged in the frame of a air guide are displaced out of the defined desired installation position.

### Object

Taking the state of the art set forth in the opening part of this specification as the basic starting point together with the advantages linked thereto the object of the invention is to at least partially avoid those disadvantages and in particular to permit simple, reliable and as maintenance-free as possible return to the basic position.

### Attainment of the Object/Invention

According to the invention that object is already attained by the features of the independent claims. Advantageous but not imperative developments are recited in the appendant claims.

According to the invention therefore that object is attained in that the spacer parts engage telescopically into each other, that is to say a respective first spacer part receives the complementary second spacer part relatively moveably in concentric relationship along the common spacer longitudinal axis. The two spacer parts are therefore coaxial, that is to say arranged in mutually concentric relationship, and the return spring is accommodated between those spacer parts for forming a closed, telescopically adjustable-length spring system, wherein the spacer parts enclose the at least one spring, that is to say accommodate it in them. The spacer parts are therefore arranged coaxially along the spacer longitudinal axis or a plurality of spacer longitudinal axes and accommodate the at least one return spring between them.

Accordingly the spacer parts protect the return spring from dirt and therefore shield it externally.

The invention is based on the concept that the system of the acting force is arranged in line with a guide designed concentrically as a “closed system”. Thus the spacer parts which respectively include an inner spacer part and an outer spacer part form a telescopic closed system for accommodating the compression springs.

That structure with the return springs accommodated in the interior allows the system to be returned automatically to the basic position upon an accident (crash) without the workshop having to be visited for that purpose and assemblies having to be replaced.

The concentric guide also prevents tilting and the return springs oriented for the acting force transmit the force without torques because they are also accommodated concentrically in the system.

According to the invention the spacer parts can be adapted to deploy a damping action in conjunction with the spring. That can be effected by a suitable configuration of the return spring or however also the joining surface, which are of a complementary configuration and slide against each other, of the spacer parts, for example by conical enlargement of the joining surfaces in the joining direction upon being compressed in a crash situation.

As the return spring is arranged concentrically, that is to say coaxially with respect to the spacer longitudinal axis, it exerts no torque between the fixing points of the spacer parts to the joining bodies, in contrast to the state of the art, that is to say the inwardly disposed holding part to the inner spacer part and the outwardly disposed attachment to the outer spacer part. That avoids tilting of the spacer parts and in that respect improves proper operability and service life.

It is also possible to provide in mutually juxtaposed relationship two or more return springs for forming a spring arrangement which are preferably arranged equidistantly from the spacer longitudinal axis arranged centrally between the spring longitudinal axes, for avoiding unwanted lever arms and tilting that is linked thereto.

Particularly preferably the inner spacer part is in the form of an insertion part and the outer spacer part is in the form of a guide sleeve or receiving part into which the inner spacer part can be inserted. The inner spacer part is therefore received longitudinally displaceably in the outer spacer part.

Preferably the inner spacer part is at least partially adapted for fixing the at least one return spring, which in particular can be effected by it being at least partially adapted to receive the at least one return spring, that is to say it has a connection-like insertion or receiving portion which at least partially encloses one or more return springs.

To provide for particularly harmonic force deployment and optimisation of the structural space, that is to say a reduction in the space required for the return springs, preferred embodiments provide a plurality of compression or return springs accommodated in the spacer, for forming a spring arrangement, in particular two return springs arranged spaced equidistantly from the central longitudinal axis.

Preferably there are provided spring arrangements having an even number of return springs which to provide a harmonic force effect are spaced uniformly in relation to a common central longitudinal axis, these preferably being arranged centrally in relation to the spring longitudinal axes of the return springs of the spring arrangement.

Preferably the spring arrangement includes at least two return springs in mutually juxtaposed relationship, preferably such that the central longitudinal axes of the return springs lie on a common plane, in particular a plane extending horizontally in the installed position.

To avoid lever arms the spring arrangement is preferably of such a design that the central longitudinal axes of the return springs are arranged spaced equidistantly, that is to say equally, from a central axis of the spring arrangement, that extends between said central longitudinal axes of the return springs.

It is also in accordance with the invention to provide spring arrangements having more than two return springs.

It is possible for example to adopt a lateral arrangement at the upper end and the lower end of a frame in the form of an air flap control means. In that case the frame encloses or defines a window. Arranged in the window formed by the frame are a plurality of displaceable air control flaps which are arranged in mutually superposed relationship in a shutter blind-like arrangement for controlling the air flow to an engine compartment behind the frame.

Such an air flap control is preferably of a substantially rectangular configuration and is arranged extending in the longitudinal direction at the front end in an engine compartment. Preferably four spacers are disposed between the corners of the frame, that is to say respectively at the upper and lower ends of the frame and the engine compartment disposed behind the frame.

Each spacer includes a spring arrangement having two or more return springs.

A particularly preferred design is a configuration having three return springs per spacer, wherein two return springs extend with their longitudinal axes on a horizontal plane arranged in the engine in the installed position while the third return spring is preferably arranged displaced vertically downwardly or upwardly in relation to the return spring respectively arranged at the outside on the frame, of the return springs that extend in the horizontal plane.

To prevent the inner spacer part from dropping out of the outer spacer part an abutment can be provided between the spacer parts. It can also be adapted to carry the force of the return spring or springs in the basic position.

Preferably the system is so adapted that the return springs are unloaded or are quite lightly stressed when the abutment is in operation between the telescopically acting spacer parts.

The abutment between the spacer parts can thus provide that the pin is relieved of load in the basic position. The system is accordingly preferably designed in such a way that the abutment in the basic position is such that the spacing of the attachment relative to the holding part is established or defined by way of the length of the at least one return spring or springs and the abutment carries the force of the return spring or springs. Return to the basic position is thus effected automatically and latching into the basic position is implemented by the geometrical configuration of the pin, preferably with a lower force than latching disengagement. In addition that configuration affords the advantage of relieving the load on the pin in the basic position.

In a preferred embodiment the interengaging joining surfaces of the spacer parts are adapted to have a damping and/or floating relationship. In this case the term floating is used to mean that the disengagement force due to the impact is overcome, leads to release of the system, and then is automatically moved back into the basic position by the return spring.

Damping can be achieved by the return spring itself or in addition, for example by forming a conicity at the complementary joining surfaces.

In the particularly preferred embodiment provided at the complementary spacer parts is a crash holding system, wherein provided at a spacer part is a clamp or a crash clamp into which a pin provided at the complementary other spacer part latchingly engages. That pin which is accommodated in the clamp in the basic position is fixed until a disengagement force in the clamp is exceeded. It is only after the disengagement force is exceeded, that corresponds to a defined impact, that the pin is released from the latching engagement of the clamp and thus permits the relative movement of the spacer parts along the spacer longitudinal axis relative to each other. Preferably that disengagement force or defined force is between 300 and 500 Newtons. Accordingly the spacer preferably includes at a spacer part a pin which in the basic position is held in a clamp (crash clamp) of the complementary other joining partner, which upon deflection of the attachment and the effect of the defined disengagement force of the pin out of the clamp thus allows deflection of the attachment.

The crash system can be adapted to different latching disengagement forces by different geometrical configurations of the pins and clamps of a complementary configuration. That affords the advantage that until the required disengagement force of the clamp is exceeded the spring rate of the return or compression springs can be set low because the spring force thereof is required only for return to the basic position.

Preferably the crash system or the clamp is so designed that it has a higher disengagement force of about 300 to 500 N than the re-engagement force (return to the original position) of about 40 to 70, particularly preferably 50 to 60 Newtons. In particular that can be achieved in that provided between the clamp and the pin on the sides directed towards each other are inclined run-on surfaces which facilitate re-engagement.

The pin can be geometrically adapted for varying the disengagement force (force for releasing the pin from the clamp) and the engagement force (force for restoring the pin into the resilient clamp). Thus it can be for example round but it can also be slightly oval with somewhat flattened sides or with inclined run-on surfaces which act in the joining direction with the clamp and which simplify re-engagement or reduce the force. In principle the transverse dimension of the pin extending transversely to the latching and unlatching direction can be altered to vary the latching and unlatching force.

Adaptation of the system to different latching disengagement forces can be implemented by the clamp (crash clamp) used and its geometrical configuration, by virtue of a geometrically different configuration of the pin. When the defined disengagement force of the clamp is exceeded, at which therefore the clamp releases the pin, the spring rate can be set low. The spring force of the compression spring is thus required really only for return to the basic position whereas, for return to the original position, that is to say for the pin to be received in the clamp, a lower force may be required. Preferably that is achieved by the provision of interengaging inclinations or inclined run-on surfaces being provided at the joining partners as between the clamp and the pin, which facilitate insertion of the pin into the clamp, whereas release for overcoming the disengagement force requires the higher force. The disengagement force can also be influenced by the clamp engaging engagement surfaces of the lateral complementary slots of the pin.

Preferably the clamp is provided at the outer spacer part and the pin at the inner spacer part, although it will be appreciated that this may also be otherwise.

Preferably the clamp and the pin are in one piece on the spacer parts, in particular being injection-moulded integrally thereon, but alternatively can also be joined to the spacer parts, for example being fitted into or on to same.

In a stable embodiment the spacer is a component part of a spacer arrangement comprising a plurality of complementary spacer parts each having a respective inner spacer part and a corresponding outer spacer part which are spaced from each other by way of a spacer bridge and are connected together. By virtue of such a spacer bridge it is possible to provide for even more precise guidance for the attachment upon an impact. Preferably the spacer parts are arranged spaced above each other in the installed position so that an upper spacer is arranged above a lower spacer in the installed position and they are connected together by way of the spacer bridge.

In the preferred embodiment the spacer bridge or the spacer arrangement is in the form of a plastic component, preferably in the form of a plastic injection moulding.

Preferably the spacer bridge respectively includes two spacer parts which are the upper ones in the installed position and which in the installed position are arranged on both sides of the attachment above lower spacer parts.

In addition the invention concerns a mounting method for a motor vehicle assembly of the above-described kind. A particularly simple arrangement or mounting of the attachment to the holding part can be implemented by simple insertion or pushing in. For that purpose there can be provided insertion parts which can be connected to the holding part at the spacer parts which are disposed downwardly in the installed position, which insertion parts in particular can be in the form of downwardly projecting pins (insertion pins), screws or the like for insertion into the holding part and provided at the upper end or at the inner spacer parts which are upward in the installation position is a fixing eye or a fixing lug, with which the upper inner spacer part in the installed position can be snap-fitted on to the holding part or can be screwed thereto. By virtue of that simple design the attachment can be fitted into the holding part with the lower insertion parts or at least one insertion part, possibly being pivoted about that lower pre-fixing point and can then be screwed or latched to the upper fixing eye or the upper inner spacer part with the holding part in the definitive installed position.

A particularly maintenance-friendly design configuration for the spacer assembly provides that crash arrangements including clamps and pins cooperating therewith are arranged on the mutually facing inward sides of the mutually spaced spacer parts so that the clamps and the pins are therefore shielded from dirt and fouling externally by the bodies of the spacer parts.

In the preferred embodiment the holding part is in the form of an engine and the attachment is in the form of a frame having a window, particularly preferably including an air flap control means. The air flap control means is substantially a frame-like component defining a front surface, wherein provided in that front surface is a window or opening enclosed by the frame, which can be opened and closed by way of adjustable flaps. By adjusting the flaps therefore the feed flow of air into a region behind same can be regulated, in particular into an engine compartment, for which purpose the air flap control means therefore involves an essential component of heat management for the engine.

Preferably the motor vehicle assembly is so designed that the frame can be fitted from above or from the front.

Separately from the motor vehicle assembly the invention however also concerns the spacer for relatively moveably fixing an attachment to a component in itself which is substantially stationary and which functions as a holding part, in particular for use in a motor vehicle, for example a body, an engine or the like, wherein that spacer includes two spacer parts which are moveable relative to each other along a spacer longitudinal axis, namely an inner spacer part which is disposed inwardly in the installed position for fixing to the holding part and an outer spacer part disposed outwardly in the installed position for fixing to the attachment. Provided between the spacer parts is a linear guide which extends along the spacer longitudinal axis, and along which the two spacer parts are displaceable in relation to each other. A return spring is operative between the spacer parts, which counteracts a deflection after a force acts thereon.

According to the invention the complementary spacer parts are of telescopically interengaging configuration and the return spring is accommodated between the spacer parts for forming a concentric enclosed telescopically adjustable-length spring system.

Further features and advantages of the invention will be apparent from the specific description hereinafter of preferred embodiments with reference to the accompanying drawings. In this respect directional terminology like for example “upward”, “downward”, “forward”, “rearward”, “front”, “rear” and so forth is used in relation to the orientations of the Figure or Figures being described. As components of embodiments can be positioned in a number of differing orientations the directional terminology serves for illustration and is in no way limiting. It will be appreciated that other embodiments can be used and structural or logical modifications can be made without thereby departing from the scope of protection of the present invention. The following detailed description is not to be interpreted in a limiting sense.

In the context of this description the terms “connected”, “joined” and “integrated” are used to describe both a direct and also an indirect connection, a direct or indirect join or direct or indirect integration.

Identical or similar components are denoted by a identical references in the Figures insofar as that is desirable. The views in the Figures are substantially true to scale. However certain regions can be shown on an enlarged scale as will be apparent to the man skilled in the art to illustrate details. In addition the drawings can be strikingly simplified and do not contain every detail which is possibly present in a practical implementation.

Unless otherwise specified the indefinite article and the definite article refer not just to an individual component but are to be interpreted as “at least one”. The terminology includes the above-mentioned words, deviations therefrom and similar meanings.

It should further be appreciated that the terms “approximately”, “substantially” and similar terms in connection with the dimensions and a property of a component of the invention describe the described dimension and property not as a strict limit or parameter and do not exclude minor deviations therefrom, that are functionally similar. At least parts of description with numerical parameters also include variations in those parameters in accordance with mathematical and manufacturing principles in the state of the art, for example roundings, deviations and other systematic errors, manufacturing tolerances and so forth.

Finally in relation to a plurality of identical components or elements, for reasons of clarity, only a respective one is denoted by a reference numeral.

All features of the respective embodiments are deemed in this case to be disclosed independently of each other generally in the context of the invention.

In the drawings:

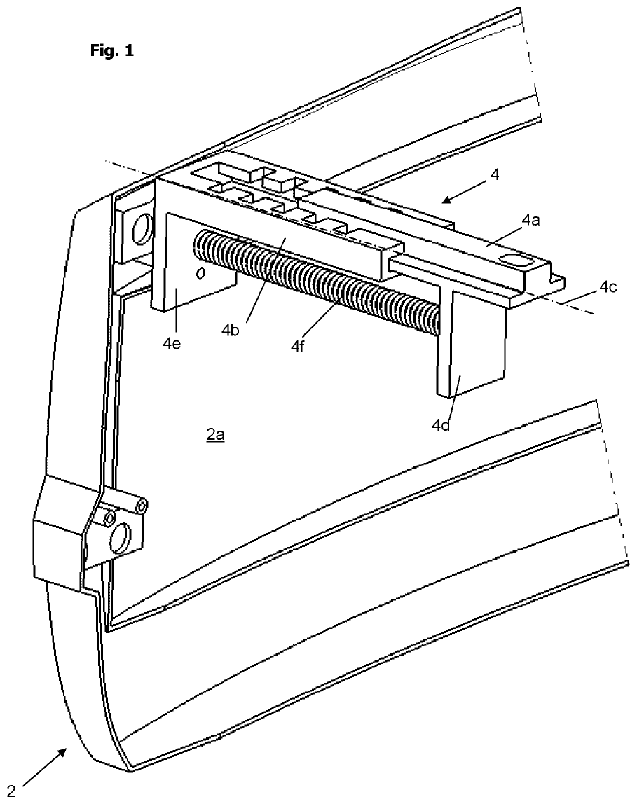

FIG. 1 shows an isometric partial side view of a motor vehicle assembly known from the state of the art,

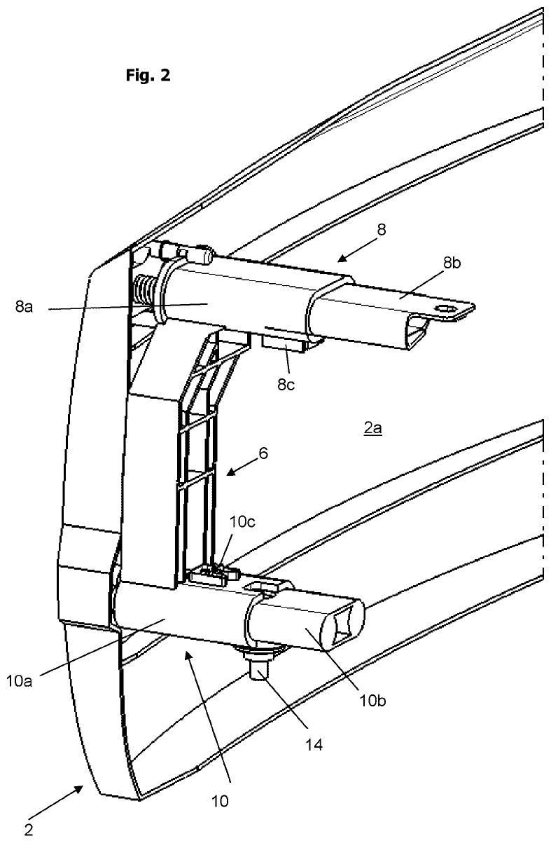

FIG. 2 shows an isometric partial side view of a motor vehicle assembly according to the invention (without holding part),

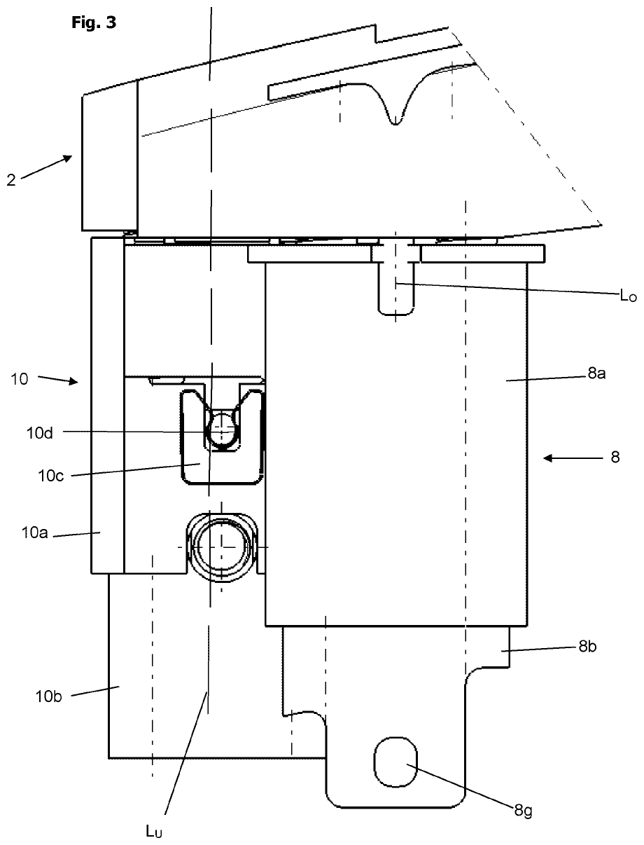

FIG. 3 shows an enlarged detail partial plan view of the motor vehicle assembly of FIG. 2,

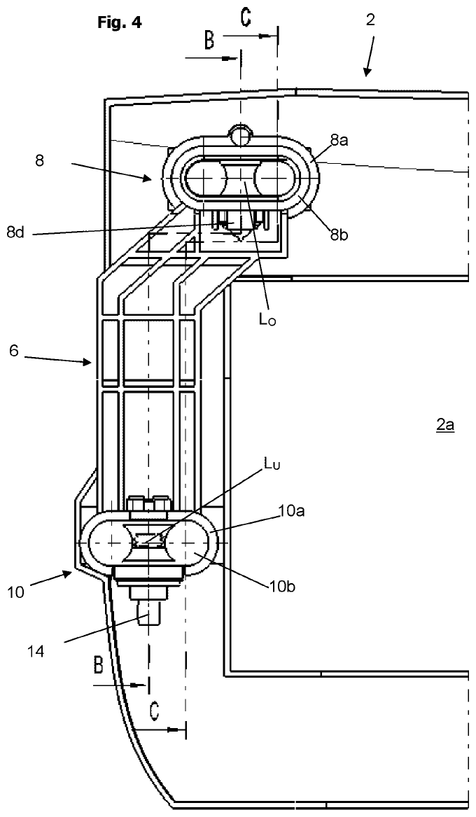

FIG. 4 shows a partial rear view of the motor vehicle assembly shown in FIG. 3,

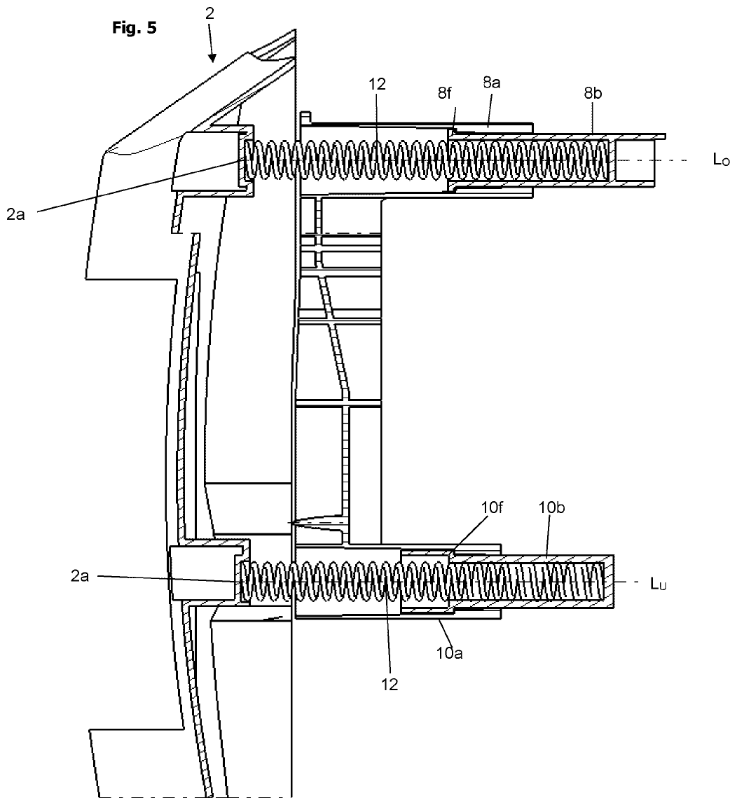

FIG. 5 shows a longitudinal section through the motor vehicle assembly along line C-C shown in FIG. 4 in the basic position,

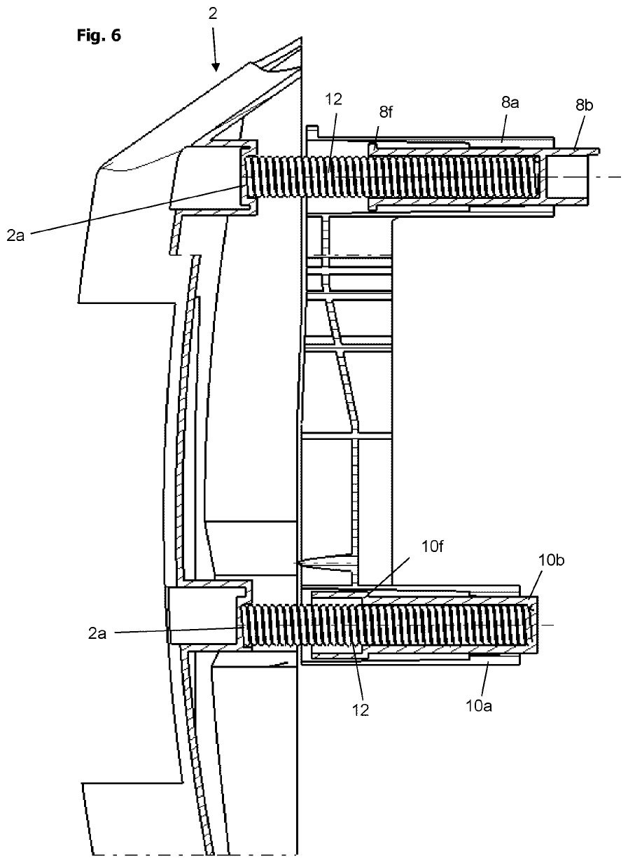

FIG. 6 shows a longitudinal section through the motor vehicle assembly along line C-C shown in FIG. 4 in the accident situation (crash), and

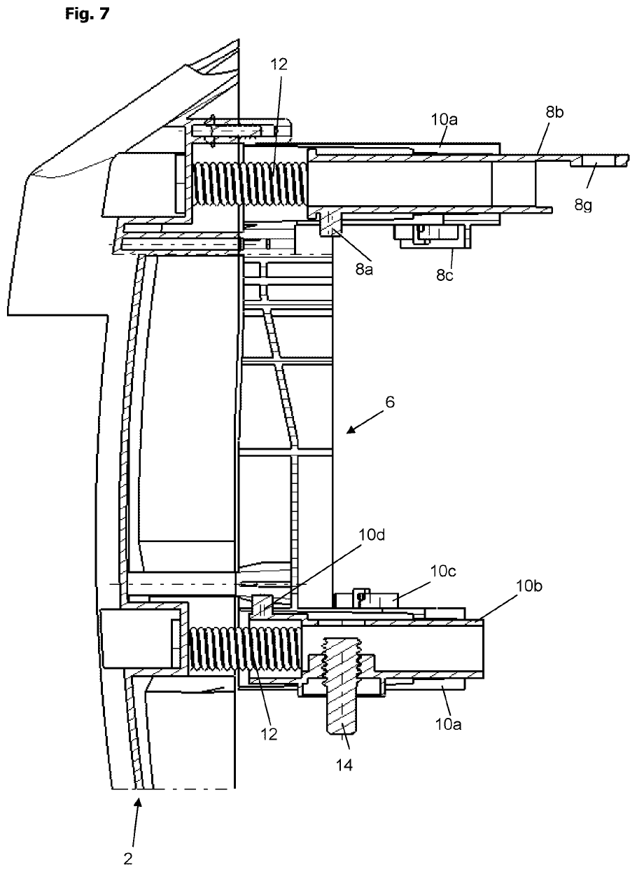

FIG. 7 shows a longitudinal section through the motor vehicle assembly along line B-B shown in FIG. 4 in the accident situation (crash), to illustrate latching disengagement.

FIG. 1 shows an isometric side view of a motor vehicle assembly from the state of the art without the body functioning as the holding part, that is to say showing only the attachment in the form of the frame 2 which is fixed to the body (not shown) by way of a plurality of spacers 4.

The frame in this case includes or defines a window 2a which is visible from the exterior. Accommodated rotatably in that window are flaps (not shown) with which the window can be selectively closed and opened for controlling the feed of air to an engine compartment behind the frame.

The spacer 4 according to the state of the art includes an inner spacer part 4a which is screwed internally to the body and which together with an outer spacer part 4b forms a length-adjustable displaceable dovetail guide. The outer spacer part 4b and the inner spacer part 4a are respectively screwed externally to the frame and internally to the body. Transverse bars 4d, 4e are provided transversely to the spacer longitudinal axis 4c which extends through the centre of the dovetail guide between the inner spacer part 4a and the outer spacer part 4b, with a return spring 4f being arranged between the bars 4d, 4e. That return spring 4f moves the spacer 4 back into the basic position or into the vicinity of the basic position after an accident (crash), and therefore spaces the spacer parts 4a, 4b which were firstly moved relatively towards each other, away from each other again into the proximity of the basic position.

FIG. 2 in contrast shows a left-side isometric side view of a motor vehicle assembly according to the invention in the form of a spacer arrangement comprising two spacers according to the invention which are arranged one above the other in the installed position and which are connected together by way of a spacer bridge 6.

The spacer bridge 6 includes an upper spacer 8 and a spacer 10 which is a lower spacer in the installed position, the spacers being spaced vertically from each other by way of the spacer bridge 6 and being fixed at the top and lower sides to the frame at the inside thereof. A corresponding spacer bridge 6 is fixed at the opposite end (not shown) of the frame 2, that is to say at the two ends of the frame 2.

The outer spacer parts screwed to the frame 2 are respectively in the form of guide sleeves 8a, 10a screwed to the frame 2 and are preferably in one piece with the spacer bridge 6. The inner spacer parts which are in the form of guide elements 8b, 10b are longitudinally displaceably accommodated in the guide sleeves 8a, 10a. The guide elements 8b, 10b at the inside have hollow-cylindrical spring receiving means which are respectively equidistantly spaced from the central spacer longitudinal axis L_{O},L_{U} and into which two compression springs 12 are respectively fitted. The compression springs 12 lie with their rear ends against the inner end of the guide elements 8b, 10b and bear with their front ends in spring seats for embracingly accommodating the front ends of the springs on the frame 2.

As the rear view shown in FIG. 4 shows the spacers 8, 10 are arranged displaced from each other in the vertical direction so that the lower spacer 10 is arranged further outwardly relative to the outer edge of the frame 2 from the upper spacer 8 so that the central longitudinal axes L_{O},L_{U} of the spacers 8, 10 are arranged displaced vertically relative to each other and the upper spacer longitudinal axis L_{O} is therefore displaced further inwardly than the lower spacer longitudinal axis L_{U}.

The spacer bridge 6 which is also referred to as the crash clamp therefore includes in the present case the outer spacer parts which in this example are in the form of the guide sleeves 8a, 10a. Each spacer 8, 10 comprises an outer spacer part which in the installed position is disposed outwardly in relation to the engine, in the form of a guide sleeve 8a, 10a accommodating longitudinally displaceable telescopic guide elements 8b, 10b which have hollow-cylindrical receiving means which are displaced in parallel relative to the spacer longitudinal axes L_{O},L_{U} and spaced from each other for return springs 12 received in the guide elements 8b, 10b.

Thus the spacer parts respectively including an inner spacer part and an outer spacer part respectively form a closed system for accommodating the compression springs.

Each spacer 8, 10 therefore respectively accommodates in pairs two return springs 12 which are arranged horizontally in mutually juxtaposed relationship on both sides equally spaced from the respective spacer longitudinal axis L_{U},L_{O}, which with their inward ends sit on hollow-cylindrical spring receiving means provided on the guide element 8b, 10b and externally bear against the holding frame 2 in spring seats 2a which in the present case are in the form of cylindrical inserts.

FIG. 3 shows a plan view of the spacer bridge 6 with the upper spacer 8 and the lower spacer 10. Formed on the mutually facing insides of the spacers 8, 10 are clamps 8c, 10c functioning as crash clamps, in one piece on the outside of the upper guide sleeve 8a and the lower guide sleeve 10a, which cooperate with pins 8d, 10d provided at the outer peripheral surfaces of the guide elements 8b, 10b. Those pins 8d, 10d in the basic position snappingly engage into latching projections provided internally on the longitudinal limbs of the clamps 8c, 10c and fix the spacer parts in the basic position in that way. In that basic position the return springs 12 are either completely relieved of load or are very slightly loaded, which enhances proper operability and avoids material fatigue.

Provided on the insides of the spacers 8, 10, that are directed towards each other, are respective clamps 8c, 10c, on the guide sleeves 8a, 10a, in particular being formed integrally thereon and forming a resilient clamp region which is closed on three sides and into which can be latched from one side a pin 8d, 10d which is connected to the respective complementary other spacer part, in the present case therefore the guide element 8b, 10b, more specifically being formed at the outer peripheral surface projecting from the guide element 8b, 10b.

Provided internally between the guide sleeves 8a, 10a and the guide elements 8b, 10b at the mutually facing front end of the guide elements 8b, 10b is an abutment 8f, 10f which engages in an internal shoulder of complementary configuration in the guide sleeves 8a, 10a when the motor vehicle assembly is in the basic position in which the compression springs 12 are in the rest position and the pins 8d, 10d are fixed in the clamps 8c, 10c.

Screwed into the lower end of the lower spacer 10 is an insertion pin 14 which can be inserted into a corresponding opening on the engine or the body in the context of the mounting procedure. After insertion of that pin 14 into the respective associated component the motor vehicle assembly is then screwed at the inward end of the upper guide elements 8b through an internal fixing eye 8g at the top side to the corresponding holding part (body or engine).

FIG. 5 shows a longitudinal section along the line C-C as shown in FIG. 4 of the motor vehicle assembly in the basic or rest position.

FIG. 6 in contrast shows the longitudinal section through the motor vehicle assembly along the line C-C as shown in FIG. 4 in the case of an accident or crash with compressed compression springs 12, wherein the abutments 8f, 10f of the guide elements 8b, 10b are spaced from the internal shoulders of the guide sleeves 8a, 10a.

FIG. 7 shows a longitudinal section along the central longitudinal axes of the spacers 8, 10 along the line B-B shown in FIG. 4 upon an accident or crash, in which case therefore the pins 8d, 10d are disengaged from the clamps 8c, 10c.

The subject-matter of the present invention arises not just from the subject-matter of the individual claims but from the combination of the individual claims with each other. All features and recitals disclosed in the documents—including the Abstract—in particular the spatial configuration shown in the drawings are claimed as essential to the invention insofar as they are novel individually or in combination over the state of the art.

### LIST OF REFERENCES

2 frame
2a spring seat
4 spacer
4a inner spacer part
4b outer spacer part
4c spacer longitudinal axis
4d,e transverse bar
4f return spring
6 spacer bridge
8 upper spacer
8a upper guide sleeve
8b upper guide element
8c clamp
8d pin
8f abutment
8g fixing eye
10 lower spacer
10a lower guide sleeve
10b lower guide element
10c clamp
10d pin
10f abutment
12 return spring
14 insertion pin
L_{O} upper spacer longitudinal axis
L_{U} lower spacer longitudinal axis

1. A motor vehicle assembly including a stationary holding part of a motor vehicle, that functions as a holding or mounting body, for example a vehicle body, an engine or the like, an attachment which is arranged moveably relative to the holding part and at least one spacer extending between the holding part and the attachment for fixing the attachment to the holding part, wherein the spacer fixes the attachment in a basic position spaced with respect to the stationary holding part and can be transferred by the action of a force into a deflection position which is different from the basic position and which is closer to the stationary holding part, wherein the at least one spacer includes at least two mutually relatively moveable spacer parts, namely an inner spacer part which is disposed inwardly in the installed position and adapted for fixing to the holding part and an outer spacer part disposed outwardly in the installed position adapted for fixing to the attachment, wherein the spacer parts are displaceable relative to each other along a common spacer longitudinal axis, preferably in the form of a linear guide, wherein disposed between the spacer parts is a return spring (12) which counteracts the deflection after the action of the force, wherein the spacer parts engage telescopically into each other, and the return spring (12) is received in the spacer parts to form an enclosed telescopically adjustable-length spring system or is enclosed by same in the installed position, characterised in that there are provided at least two return springs (12) for forming a spring arrangement in the spacer parts and the spacer is adapted to accommodate the spring arrangement.

2. A motor vehicle assembly according to claim 1 characterised in that the at least two return springs (12) of the spring arrangement are arranged equally spaced from a spacer longitudinal axis (L_{O},L_{U}) extending between the spring longitudinal axes.

3. A motor vehicle assembly according to claim 1 or claim 2 characterised in that the at least two return springs (12) are arranged in mutually juxtaposed relationship in the installed position on a horizontal plane extending through the spacer longitudinal axis (L_{O},L_{U}).

4. A motor vehicle assembly according to one of claims 1 to 3 characterised in that the inner spacer part is in the form of an insertion part and the outer spacer part is in the form of a guide sleeve (8a, 10a) or receiving part and the inner spacer part is received longitudinally displaceably in the outer spacer part.

5. A motor vehicle assembly according to one of claims 1 to 4 characterised in that the inner spacer part is at least partially adapted to receive the at least one return spring (12).

6. A motor vehicle assembly according to one of the preceding claims characterised in that an abutment (8f, 10f) is provided between the spacer parts.

7. A motor vehicle assembly according to one of the preceding claims characterised in that the inner spacer part and the outer spacer part are designed in damping and/or floating fashion.

8. A motor vehicle assembly including a stationary holding part of a motor vehicle, that functions as a holding or mounting body, an attachment which is arranged moveably relative to the holding part and at least one spacer extending between the holding part and the attachment for fixing the attachment to the holding part, wherein the spacer fixes the attachment in a basic position spaced with respect to the stationary holding part and can be transferred by the action of a force into a deflection position which is different from the basic position and which is closer to the stationary holding part, wherein the at least one spacer includes at least two mutually relatively moveable spacer parts, namely an inner spacer part which is disposed inwardly in the installed position and adapted for fixing to the holding part and an outer spacer part disposed outwardly in the installed position adapted for fixing to the attachment, wherein the spacer parts are displaceable relative to each other along a common spacer longitudinal axis, preferably in the form of a linear guide, wherein disposed between the spacer parts is a return spring (12) which counteracts the deflection after the action of the force, wherein the spacer parts engage telescopically into each other, and the return spring (12) is received in the spacer parts to form an enclosed telescopically adjustable-length spring system or is enclosed by same in the installed position, characterised in that provided at the complementary spacer parts is a clamp (8c, 10c) having a complementary pin (8d, 10d), that is to say on a spacer part a clamp (8c, 10c) and on the complementary other spacer part a pin (8d, 10d) cooperating with the clamp (8c, 10c) in the basic position.

9. A motor vehicle assembly according to claim 8 characterised in that the clamp (8c, 10c) and/or the pin (8d, 10d) are of such a configuration that for unlatching (unlatching force) a higher force is required than for restoring the pin (latching force) into the clamp after an accident.

10. A motor vehicle assembly according to claim 9 characterised in that a flat portion, inclined run-on surfaces acting in the joining direction or the like are provided between the clamp (8c, 10c) and the pin (8d, 10d).

11. A motor vehicle assembly according to one of the preceding claims characterised in that it includes a spacer arrangement having a plurality of spacer parts each with a inner spacer part and a corresponding outer spacer part which are spaced from each other by way of a spacer bridge (6) and are or can be connected together.

12. A motor vehicle assembly according to claim 11 characterised in that the spacer bridge (6) respectively includes two spacer parts which are upper parts in the installed position and which in the installed position are arranged above lower spacer parts.

13. A motor vehicle assembly according to claim 12 characterised in that the upper inner spacer parts include a fixing eye (8g) for screwing to the stationary component and the lower spacer parts include an insertion part, in particular in the form of a screw (14), for insertion into the holding part.

14. A motor vehicle assembly according to claim 12 or claim 13 characterised in that a plurality of clamps (8c, 10c) are provided at insides of the spacer parts, which insides face towards each other in the installed position.

15. A motor vehicle assembly according to claims 13 and 14 characterised in that the lower spacer parts include an insertion part adapted for insertion at the underside into the holding part and the upper spacer parts include a fixing eye (8g), an opening or a latching device adapted for fixing at the top side to the holding part.

16. A motor vehicle assembly according to claim 15 characterised in that the insertion part includes an insertion pin (14).

17. A motor vehicle assembly according to one of the preceding claims characterised in that the holding part is in the form of an engine and the attachment is in the form of an air flap control means.

18. A spacer (8, 10) for relatively moveably fixing an attachment to a substantially stationary component functioning as a holding part of a motor vehicle, for example a body, an engine or the like, wherein the spacer fixes the attachment in a basic position spaced with respect to the stationary holding part and can be transferred by the action of a force into a deflection position which is different from the basic position and which is closer to the stationary holding part, wherein the spacer (8, 10) includes at least two mutually relatively moveable spacer parts, namely an inner spacer part which is disposed inwardly in the installed position and adapted for fixing to the holding part and an outer spacer part disposed outwardly in the installed position adapted for fixing to the attachment, wherein the spacer parts are displaceable relative to each other along a common spacer longitudinal axis, preferably in the form of a linear guide, wherein disposed between the spacer parts is a return spring (12) which counteracts the deflection after the action of the force, characterised in that the spacer parts engage telescopically into each other, and the return spring is received in the spacer parts to form an enclosed telescopically adjustable-length spring system or is enclosed by same in the installed position.

19. A mounting method for a motor vehicle assembly, in particular according to one of the preceding claims, wherein an attachment is spaced in relation to a holding part by way of the interposition of at least one spacer and is held relatively moveably along a spacer longitudinal axis (L_{O},L_{U}), characterised in that the spacer parts which are disposed downwardly in the installed position include an insertion part which can be connected to the holding part for insertion into the holding part and provided at the upper end or at the inner spacer parts which are disposed upwardly in the installed position is a fixing eye, a fixing lug or the like, with which the upper inner spacer part in the installed position snaps on to or is latched on to the holding part or is screwed thereto.
